(19) United States
(12) Patent Application Publication
(10) Pub. No.: US 2013/0258139 A1
(43) Pub. Date: Oct. 3, 2013

(54) IMAGING APPARATUS

(71) Applicant: Keisuke Omori, Osaka-shi (JP)

(72) Inventor: Keisuke Omori, Osaka-shi (JP)

(73) Assignee: SHARP KABUSHIKI KAISHA, Osaka-shi, Osaka (JP)

(21) Appl. No.: 13/991,971

(22) PCT Filed: Nov. 14, 2011
(86) PCT No.: PCT/JP2011/076142

§ 371 Date: Jun. 6, 2013

(30) Foreign Application Priority Data
Dec. 7, 2010 (JP) 2010-272130

(51) Int. Cl. H04N 5/265

(52) U.S. Cl. CPC H04N 5/265
USPC 348/239

(57) ABSTRACT

An imaging apparatus is provided that can obtain a high image quality combination image with a proper exposure while expanding a dynamic range. The imaging apparatus 1 includes multiple imaging systems 2, a parallax calculation unit 3 that calculates parallaxes of multiple images captured by the multiple imaging system 2, a determination unit 4 that determines a lightness-level relationship and a positional relationship of the photographic object in the multiple images, an exposure control unit 5 that can control the multiple imaging systems 2 to respective different exposures, based a result of the determination by the determination unit 4, and an image combination unit 6 that combines the multiple images based on the parallaxes calculated by the parallax calculation unit 3 and the exposures set by the exposure control unit 5.

### TECHNICAL FIELD

The present invention relates to an imaging apparatus equipped with multiple imaging systems that image the same photographic object from different viewpoints.

### BACKGROUND ART

In recent years, an imaging apparatus, such as a digital still camera, and a digital camcorder has made a progress toward high performance and high quality. One of the factors to decide an image quality of the captured image is a dynamic range. The dynamic range in a camera is a ratio of the discernible lowest brightness to the discernible highest brightness. The dynamic range of an imaging device, such as a CCD and a CMOS, mounted on a general digital camera that is currently commercially available in the market, is approximately 2,000:1 at the most. On the one hand, a minimum brightness to maximum brightness ratio for a photographic object is 100,000:1 or more depending on a scene, and in a case of imaging such a scene, there is a problem in that when an exposure is adjusted to a light portion, a blocked-up shadow results from a shortage of an amount of light in a dark portion, and when the exposure is adjusted to the dark portion, a blown-out highlight results from a saturation in the light portion.

It is necessary to expand the dynamic range in order to prevent an image quality from deteriorating due to the blocked-up shadow and the blown-out highlight. Except for the expansion of the dynamic range of the sensor itself, for example, a technology is disclosed in PTL 1, in which the dynamic range is expanded by combining multiple images with different exposures. In this method, because the image is captured multiple times with the same imaging system, deviations occur in the multiple images used in the combination in a case where the photographic object is a moving object, thereby causing a problem of a difficulty with the combination.

Furthermore, to avoid the deviations when imaging the moving photographic object, for example, a multiple-views-type camera is proposed in PTL 2, which combines images which are obtained by imaging the photographic with the multiple imaging systems at the same time. The multiple-views-type camera includes a CCD that receives flux of light of a photographic object image and thus takes a photograph, and multiple photographing optical systems for guiding the photographic object to the CCD. In the multiple-views-type camera, optical filters, different in visible light transmissivity, are installed in the multiple photographing optical systems, respectively, and the multiple photographing optical systems take photographs of the multiple photographic object images at the same time.

### CITATION LIST

### Patent Literature

PTL 1: Japanese Unexamined Patent Application Publication No. 10-336525
PTL 2: Japanese Unexamined Patent Application Publication No. 2002-281361

### SUMMARY OF INVENTION

### Technical Problem

However, the method disclosed in PTL 2, described above, has the following problems. That is, each imaging system is set to a different exposure by equipping each imaging system with the filter, different in visible light transmissivity, but because the visible light transmissivity of the filter is fixed, an exposure difference in each imaging system is not necessarily suitable for a scene to be imaged. Furthermore, in a case where the multiple images, different in viewpoint, are used in the combination, a parallax occurs between the multiple images. For example, the closer the photographic object is to the front, the greater the parallax, and the farther the photographic object from the front, the smaller the parallax. However, because the parallax is not considered in the method disclosed in PTL 2, when the multiple images different in viewpoint are simply combined, there is a likelihood that a deviation in position will occur in each photographic object image and thus the combination will not be well made.

With the above-described actual situations in mind, an object of the present invention is to provide an imaging apparatus that is capable of obtaining a high image quality combination image with a proper exposure while expanding a dynamic range.

### Solution to Problem

To solve the problems described above, first technological means according to the present invention includes multiple imaging systems, a parallax calculation unit that calculates parallaxes of multiple images which are captured by the multiple imaging systems, a determination unit that determines a lightness-level relationship and a positional relationship of a photographic object in the multiple images, an exposure control unit that is able to control the multiple imaging systems to respective different exposures based on a result of the determination by the determination unit, and an image combination unit that combines the multiple images based on the parallaxes and the exposures.

In second technological means according to the first technological means, in a case where the determination unit determines that a light photographic object and a dark photographic object are arranged on the left side and on the right side, the exposure control unit performs control in such a manner that an exposure of the one imaging system is adjusted to the light photographic object and an exposure of the other imaging system is adjusted to the dark photographic object.

In third technological means according to the second technological means, the multiple images are configured from a first image that is captured by the one imaging system with the exposure being adjusted to the light photographic object and a second image that is captured by the other imaging system with the exposure being adjusted to the dark photographic object, the parallax calculation unit calculates the parallax from the first image and the second image, and the image combination unit combines the images by defining any one of the first image and the second image as a reference image, and by using a pixel value of the reference image with respect to a region in which the pixel value of the reference image is within a predetermined range, or using a pixel value of a region corresponding to the region of the other image with respect to a region in which the pixel value of the reference image is not within the predetermined range, when combining the images based on the parallax calculated by the parallax calculation unit.

In fourth technological means according to the first technological means, in a case where the determination unit determines that the light photographic object and the dark photographic object are arranged to the front and to the rear, the exposure control unit performs control in such a manner that the exposure control unit adjusts the exposure of the imaging system that captures a reference image defined as a reference when combining the multiple images, to the photographic object in the background and adjusts the exposure of the other imaging system to the photographic object in the foreground.

In fifth technological means according to the fourth technological means, the multiple images are configured from a first image that is captured by the imaging system that captures the image defined as the reference with the exposure being adjusted to the photographic object in the background and a second image that is captured by the other imaging system with the exposure being adjusted to the photographic object in the foreground, the parallax calculation unit calculates the parallax from the first image and the second image, and the image combination unit combines the images by using a pixel value of the first image with respect to a region in which the pixel value of the first image is within a predetermined range, or using a pixel value of a region corresponding to the region of the second image with respect to a region in which the pixel value of the first image is not within the predetermined range, when combining the images based on the parallax calculated by the parallax calculation unit.

In sixth technological means according to the first technological means, the determination unit determines that the light photographic object and the dark photographic object are alternately arranged in the depth direction, the exposure control unit performs control in such a manner that the exposure control unit adjusts the exposure of the imaging system that captures the image defined as a reference when combining the multiple images, to the photographic object different in lightness from the photographic object in the front, and adjusts the exposure of the other imaging system to the photographic object in the front.

In seventh technological means according to the sixth technological means, the multiple images are configured from a first image that is captured by the imaging system that captures the image defined as the reference with the exposure being adjusted to the photographic object different in lightness from the photographic object in the front and a second image that is captured by the other imaging system with the exposure being adjusted to the photographic object in the front, the parallax calculation unit calculates the parallax from the first image and the second image, and the image combination unit combines the images by using a pixel value of the first image with respect to a region in which the pixel value of the first image is within a predetermined range, or using a pixel value of a region corresponding to the region of the second image with respect to a region in which the pixel value of the first image is not within the predetermined range, when combining the images based on the parallax calculated by the parallax calculation unit.

In eighth technological means according to any one of the second, fourth, and sixth technological means, the exposure control unit controls the multiple imaging systems to the same exposure, the parallax calculation unit calculates the parallaxes of the multiple images captured by the multiple imaging systems that are controlled to the same exposure by the exposure control unit, the determination unit determines the lightness-level relationship of each photographic object based on the pixel values of the multiple pixels and determines a positional relationship of each photographic object based on the parallax of each photographic object calculated by the parallax calculation unit.

### Advantageous Effects of Invention

According to the present invention, when capturing multiple images different in viewpoint, a high image quality combination image with an exposure adjusted from a dark portion to a light portion can be obtained while expanding a dynamic range, by properly controlling the exposure for each imaging system depending on a photographic object and combining the obtained multiple images based on the parallax.

### BRIEF DESCRIPTION OF DRAWINGS

FIG. 1 is a block diagram illustrating a configuration example of an imaging apparatus according to one embodiment of the present invention.

FIG. 2 is a flowchart for describing one example of a method of combining images using the imaging apparatus according to the present invention.

FIG. 3 is a view schematically illustrating one example in a case where a light photographic object (light portion) and the dark photographic object (dark portion) arranged on the left side and on the right side, are imaged by using two imaging systems arranged on the left side and on the right side.

FIG. 4 is a view illustrating an image that is captured by adjusting an exposure of an imaging system 2L to the light photographic object, and an image that is captured by adjusting an exposure of the same imaging system 2L to the dark photographic object.

FIG. 5 is a view illustrating an image that is captured by adjusting the exposure of the imaging system 2L to the light photographic object, and an image that is captured by adjusting the exposure of the imaging system 2R to the dark photographic object.

FIG. 6 is a view illustrating a compensation image that results from compensating a pixel value of the left image in such a manner that points corresponding to the two images, the left and right images are consistent in lightness.

FIG. 7 is a view illustrating one example of a combination image in which both of the light photographic object and the dark photographic object are imaged at proper exposures.

FIG. 8 illustrates a view illustrating brightness ranges in which the imaging systems 2L and 2R can capture the image.

FIG. 9 is a view schematically illustrating one example in a case where the light photographic object (light portion) and the dark photographic object (dark portion) arranged in the front and in the rear, are imaged by using the two imaging systems arranged on the left side and on the right side.

FIG. 10 is a view illustrating the image that is captured by adjusting the exposure of the imaging system 2L to the light photographic object, and the image that is captured by adjusting the exposure of the imaging system 2R to the dark photographic object.

FIG. 11 is a view illustrating the combination image that is captured at the proper exposure from the light portion to the dark portion.

FIG. 12 is a view illustrating the image that is captured by adjusting the exposure of the imaging system 2L to the dark photographic object, and the image that is captured by adjusting the exposure of the imaging system 2R to the light photographic object.

FIG. 13 is a view illustrating one example of the combination image.

FIG. 14 is a view illustrating one example of an average value of lightness in each parallax of a certain scene.

FIG. 15 is a view illustrating one example of an average parallax in each lightness of a certain scene.

FIG. 16 is a view schematically illustrating one example in a case where the photographic objects, arranged in this sequence of the light photographic object, the dark photographic object, the light photographic object, are imaged by using the two imaging systems arranged on the left side and on the right side.

FIG. 17 is a view illustrating the image that is captured by adjusting the exposure of the imaging system 2L to the light photographic object, and the image that is captured by adjusting the exposure of the imaging system 2R to the dark photographic object.

FIG. 18 is a view illustrating the image that is captured by adjusting the exposure of the imaging system 2L to the light photographic object, and the image that is captured by adjusting the exposure of the imaging system 2R to the dark photographic object.

FIG. 19 is a view illustrating one example of the combination image.

FIG. 20 is a view illustrating the image that is captured by adjusting the exposure of the imaging system 2L to the dark photographic object, and the image that is captured by adjusting the exposure of the imaging system 2R to the light photographic object.

FIG. 21 is a view illustrating the image that is captured by adjusting the exposure of the imaging system 2L to the dark photographic object, and the image that is captured by adjusting the exposure of the imaging system 2R to the light photographic object.

FIG. 22 is a view illustrating one example of the combination image.

### DESCRIPTION OF EMBODIMENTS

Suitable embodiments relating to an imaging apparatus according to the present invention are described below referring to the accompanying drawings.

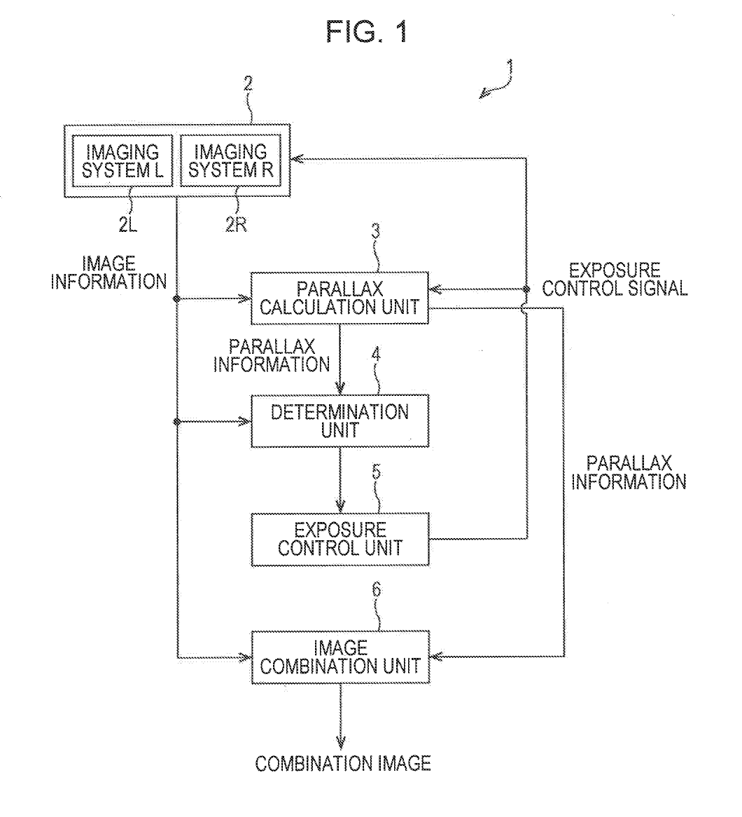

FIG. 1 is a block diagram illustrating a configuration example of the imaging apparatus according to one embodiment of the present invention. Reference numeral 1 in the drawings indicates the imaging apparatus. The imaging apparatus 1 includes multiple imaging systems 2 that image the same photographic object from different viewpoints. Two imaging systems 2 are arranged in the present example, one on the left side and the other on the right side, and each imaging system is configured from a charged coupled device (CCD), which is one example of a solid-state imaging apparatus, and an imaging optical system for guiding the photographic object to the CCD. The solid-state imaging apparatus is not limited to the CCD, and may be a CMOS. The CCD is described below as a representative example of the solid-state imaging apparatus. Furthermore, the imaging apparatus 1 includes a parallax calculation unit 3 that calculates parallaxes of multiple images captured by the multiple imaging system 2, a determination unit 4 that determines a lightness-level relationship and a positional relationship of the photographic object in the multiple images and an exposure control unit 5 that can control the multiple imaging systems 2 to respective different exposures, based a result of the determination by the determination unit 4, and an image combination unit 6 that combines the multiple images based on the parallaxes calculated in the parallax calculation unit 3 and the exposures set in the exposure control unit 5.

That is, the determination unit 4 determines the lightness-level relationship of each photographic object and the positional relationship of each photographic object with respect to the two or more photographic objects included in the same photographic object. The exposure control unit 5 controls the multiple imaging systems 2 with the different exposures, based on the result of the determination by the determination unit 4. The parallax calculation unit 3 calculates the parallaxes from the multiple image captured by the multiple imaging system 2 controlled with the different exposures in the exposure control unit 5. The image combination unit 6 combines the multiple images, based on the parallaxes calculated in the parallax calculation unit 3.

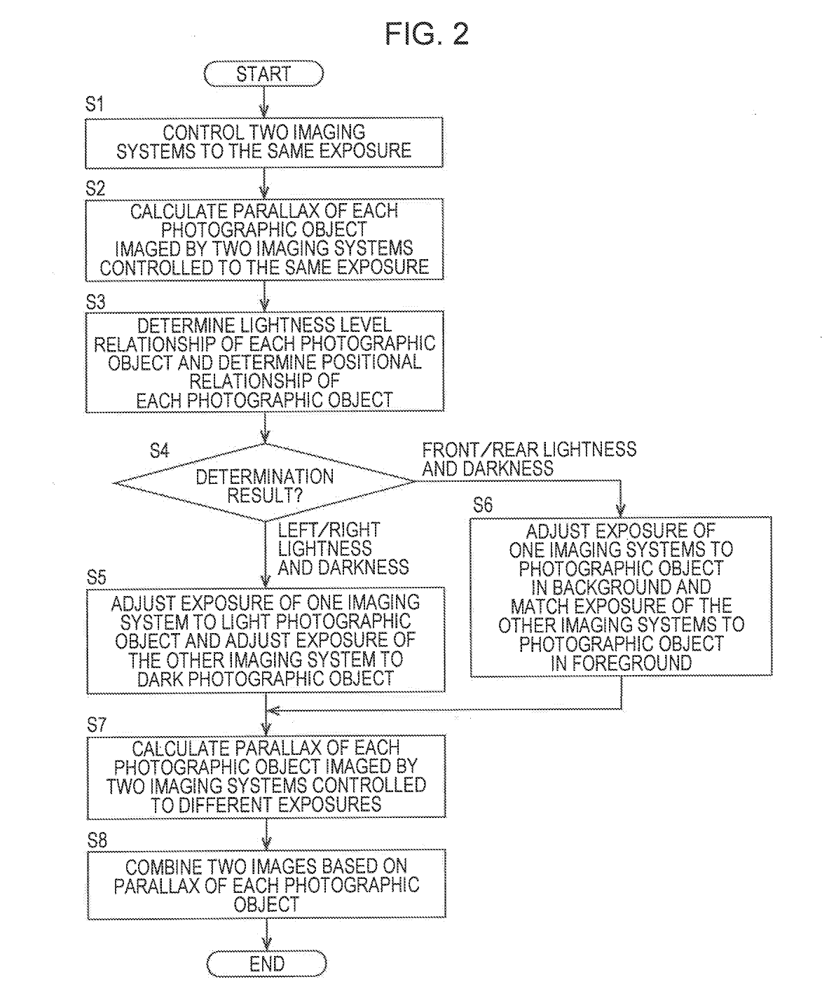

FIG. 2 is a flowchart for describing one example of a method of combining the images using the imaging apparatus according to the present invention. First the exposure control unit 5 of the imaging apparatus 1 controls the two imaging systems, that is, the left and right imaging system 2L and 2R, at the same exposure, and images the same photographic object (Step S1) using the two imaging systems 2L and 2R. The two or more photographic objects, which are different in lightness, are defined as included in the same photographic object. Furthermore, items of information on the left and right images of the same photographic object captured in Step S1 are input to the parallax calculation unit 3 and the determination unit 4. Next, the parallax calculation unit 3 calculates the parallax of each photographic object from the information on the left image and the information on the right image input by the imaging systems 2L and 2R (Step S2). For example, a block matching method, described below, can be used in calculating the parallax.

Next, the determination unit 4 obtains, for example, pixel values (RGB values) from the information on the left image and the information on the right image input by the imaging systems 2L and 2R, determines the lightness-level relationship of each photographic object, based on the obtained pixel values, and determines the positional relationship (called the arrangement relationship) of each photographic object, based on the parallax of each photographic object calculated in the parallax calculation unit 3 (Step S3). With regard to the lightness-level relationship of each photographic object, the relatively light photographic object and the relatively dark photographic object can be determined by converting the pixel values (RGB) of each photographic object to Y values (YCbCr) and, for example, performing a comparison with an average value of lightness for each photographic object. Furthermore, with regard to the arrangement relationship of each photographic object, from the relationship that the photographic object on the front side is substantially large in parallax and the photographic object in the rear side is substantially small in parallax, it can be determined that when the parallaxes of the photographic objects are different, the photographic objects are arranged in the front and in the rear, and when the parallaxes of the photographic objects are the same, the photographic objects are arranged on the left side and on the right side, when viewed from the imaging systems 2L and 2R.

Next, in a case where the result of the determination by the determination unit 4 (Step S4) is that the light photographic object and the dark photographic object are arranged on the left side and on the right side (in a case where the left side is light and the right side is dark, in the drawings), the exposure control unit 5 adjusts the exposure of one imaging system to the light photographic object and adjusts the exposure of the other imaging system to the dark photographic object (Step S5). Furthermore, in a case where it is determined that the light photographic object and the dark photographic object are arranged in the front and in the rear (in a case where the front side is light and the rear side is dark, in the drawings), the exposure control unit 5 adjusts the exposure of one imaging system to the light photographic object in the background (or to the dark photographic object), and adjusts the exposure of the other imaging system to the dark photographic object in the foreground (or to the light photographic object) (Step S6). Then, the same photographic object is imaged by the imaging systems 2L and 2R that are controlled with the different exposures in Step S5 or Step S6. The information on the left image and the information on the right image obtained by imaging the same photographic object are input to the parallax calculation unit 3 and the image combination unit 6.

Then, the parallax calculation unit 3 calculates the parallax of each photographic object from the information on the left image and the information on the right image input by the imaging systems 2L and 2R (Step S7). Then, the image combination unit 6 combines, two items of information, the information on the left image and the information on the right image input by the imaging systems 2L and 2R, into one image, based on the parallax of each photographic object calculated in the parallax calculation unit 3 (Step S8). In the flowchart, in Step S1, the imaging systems 2L and 2R are set to the same exposure, but a purpose of doing this is to correctly calculate the parallax and set the exposure suitable for the imaging systems 2L and 2R based on the calculated parallax. Furthermore, the parallax that is used in the image combining processing in Step S8 is calculated from the left and right images captured at the different exposures in each frame. In other words, for the initial frame only, the imaging is performed at the same exposure to set the exposure suitable for each imaging system, and further the imaging is performed to obtain the combination image based on the determined exposures that are different from one imaging system to another. That is, the imaging is performed two times, but because the imaging at the same exposure is not necessary after the second frame, only-one-time-imaging at the exposures that are different from one imaging system to another is possible.

### First Embodiment

According to a first embodiment of the present invention, in a case where the determination unit 4 determines that the light photographic object and the dark photographic object are arranged on the left side and on the right side, the exposure control unit 5 performs the control in such a manner as to adjust the exposure of one imaging system to the light photographic object and adjusts the exposure of the other imaging system to the dark photographic object. Moreover, the determination unit 4, as described in the flowchart in FIG. 2, may obtain the lightness and the parallax from the items of information on the left and right images captured at the same exposure, and, based on these, may determine the lightness-level relationship of each photographic object and the arrangement relationship of each photographic object. Otherwise, the determination unit 4 may obtain the lightness of each photographic object using a light measurement sensor such as a brightness photometer, and may obtain information on a distance to each photographic object using a distance measurement sensor. Furthermore, when a specification for the imaging system is known such as a focal point distance, and a pixel pitch of the imaging device (CCD sensor), the information on the distance may be calculated from the parallax of each photographic object. The lightness-level relationship of each photographic object and the arrangement relationship of each photographic object may be determined based on the information on the lightness of the photographic object and the information on the distance to the photographic object that are obtained in this manner.

Then, the same photographic object is imaged by the imaging systems 2L and 2R controlled with the different exposures as described above. Accordingly, the multiple images used in the image combination are configured from a first image that is captured by one imaging system with the exposure being adjusted to the light photographic object, and a second image that is captured by the other imaging system with the exposure being adjusted to the dark photographic object. A parallax calculation unit 3 calculates the parallax from the first image and the second image. When combining the image based on the parallax calculated by the parallax calculation unit 3, the image combination unit 6 defines any one of the first image and the second image as a reference image, and combines the images by using a pixel value of the reference image with respect to a region in which the pixel value of the reference image is within a predetermined range, or by using a pixel value of a region corresponding to a region of the other image with respect to a region in which the pixel value of the reference image is not within the predetermined range. The first embodiment is described below, with a specific example illustrated.

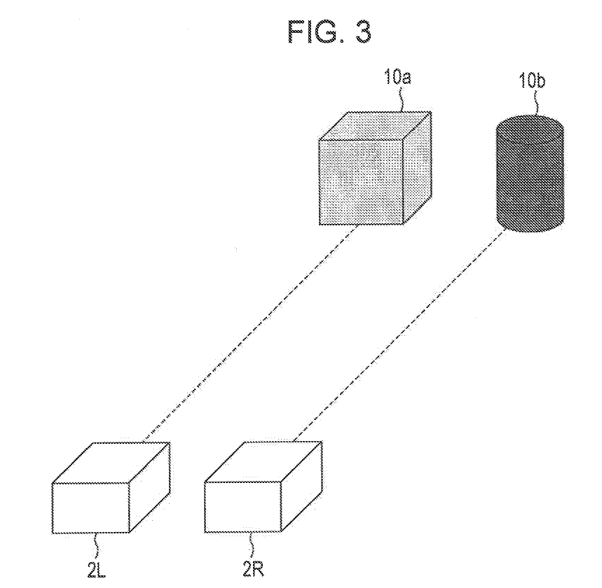

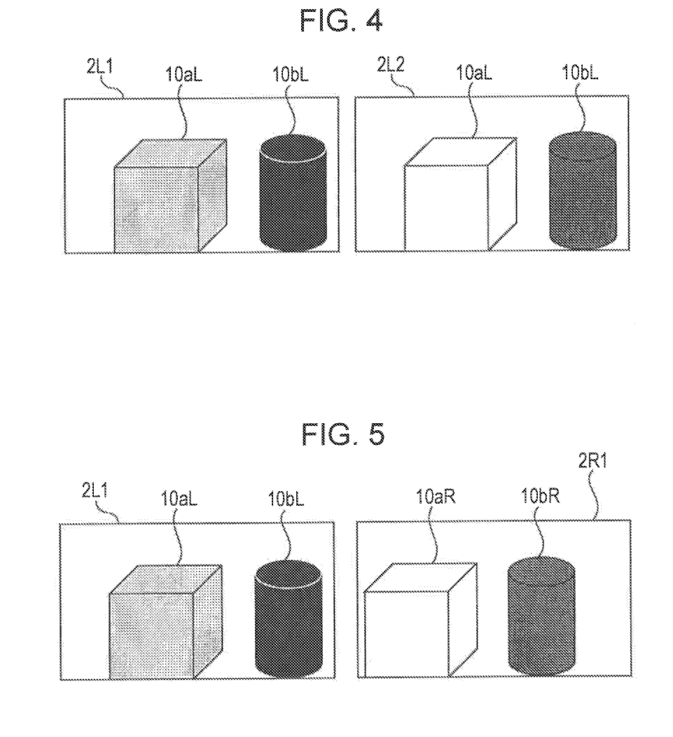

FIG. 3 is a view schematically illustrating one example in a case where the light photographic object (light portion) and the dark photographic object (dark portion) arranged on the left side and on the right side, are imaged by using the two imaging systems 2L and 2R arranged on the left side and on the right side. Reference numeral 10a in the drawings indicates the light photographic object (hereinafter referred to as light photographic object), and reference numeral 10b indicates the dark photographic object (hereinafter referred to as dark photographic object). Furthermore, FIG. 4 illustrates an image 2L1 that is captured by adjusting the exposure of the imaging system 2L to a light photographic object 10a, and an image 2L2 that is captured by adjusting the exposure of the same imaging system 2L to a dark photographic object 10b. Because a brightness ratio of the dark photographic object 10b to the light photographic object 10a is broader than a dynamic range of the imaging system 2L, a dark photographic object image 10bL has a blocked-up shadow, as shown in the image 2L1, when the exposure is adjusted to the light photographic object 10a, and a light photographic image 10aL has a blown-out highlight, as shown in the image 2L2, when the exposure is adjusted to the dark photographic object 10b.

So, according to the present embodiment, both of the captured images are combined by capturing the image by adjusting the exposure of one imaging system 2L to the light photographic object 10a, and by capturing the image by adjusting the exposure of the other imaging system 2R to the dark photographic object 10b, and thus the image is made to be obtained that is adjusted to the proper exposure and that has not the blown-out highlight and the blocked-up shadow from the light portion to the dark portion.

FIG. 5 illustrates the image 2L1 that is captured by adjusting the exposure of the imaging system 2L to the light photographic object 10a, and an image 2R1 that is captured by adjusting the exposure of the imaging system 2R to the dark photographic object 10b. The image 2L1 and the image 2R1 are equivalent to the first image and the second image according to the present invention. As a method of setting the exposure, for example, a method in which the average pixel value of the image is made to be a predetermined value, and a method in which the maximum pixel value or minimum pixel value of the image is made to be the predetermined value are known as previously-known techniques. Furthermore, in order to correctly calculate the parallax for the image combination, it is preferable that the difference in exposure between both of the imaging systems be not too great, because the absence of a blocked-up shadow region in the image captured by the imaging system 2L and the absence of a blown-out highlight region in the image captured by the imaging system 2R are desirable. The exposure can be set by controlling a diaphragm, a photographic sensitivity, a shutter speed and the like of the imaging apparatus 1. The exposure difference suitable for a scene to be imaged can be set by controlling the exposures of the multiple imaging systems 2L and 2R independently.

Next, a method of calculating the parallax used in the image combination is described. The parallax is present in the image captured with the imaging system 2L and 2R that are different in viewpoint, as the positions of the photographic objects are different in the image 2L1 and the image 2R1 in FIG. 5. For example, in a case where the image is captured with the two imaging systems of which light axes are parallel to each other, the closer the photographic object is to the front, the greater the parallax, and the farther the photographic object from the front, the smaller the parallax, and the parallax of the photographic object at infinity becomes zero. Accordingly, at the time of the image combination, the combination needs to be performed by compensating for the parallax. Moreover, in the case of the present example, the parallaxes of the two photographic objects 10a, 10b are determined as equivalent because the two photographic objects are equidistant from the imaging systems 2L and 2R. Accordingly, the parallax of any one of the two photographic objects 10a and 10b may be calculated.

As the method of calculating the parallax, for example, the block matching method is present as a well-known technique. The block matching method is a method by which a degree of similarity between the images is evaluated. In the block matching method, a certain region is selected from one image, a region that is most similar to that region is selected from the other image, and a gap in position between the region selected from one image and the region selected from the other image, which has the highest degree of similarity, is defined as the parallax. Various evaluation functions are used in evaluating the degree of similarity. For example, there is a method, called a sum of absolute difference (SAD), in which a region where a sum of absolute value of a difference between the pixel values of both of the images or between brightness values of both of the images is minimized is selected as a region that has the highest degree of similarity.

At this point, in a case where the block matching is performed by using the brightness values and the pixel values of the images captured with the different exposure settings, considering the exposure difference, the matching may be performed after compensating the brightness value or the pixel value of one image in such a manner that points corresponding to the two images are consistent in lightness. For example, in a case where the exposure difference ΔEV between the image 2L1 and the image 2R1 is 2 exposure values (EV), and the pixel values of both of the images are linear with respect to an amount of light entering a sensor, the pixels corresponding to the two images can be made consistent in lightness by multiplying the pixel value of the image 2L1 by an exponent ΔEV to the base of 2.

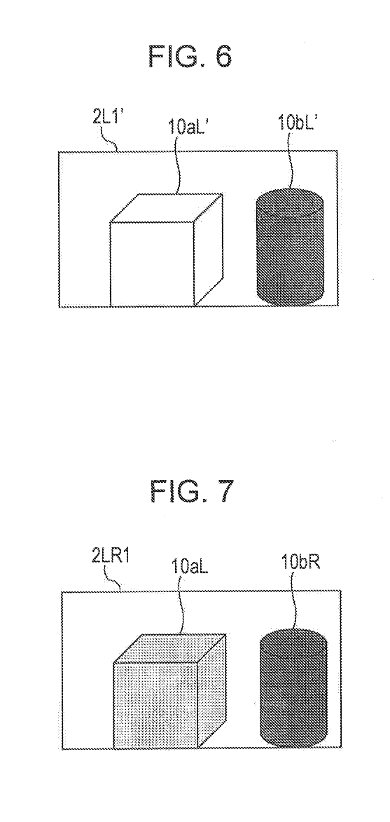

FIG. 6 illustrates the image 2L1′, which results from compensating the pixel value of the image 2L1 in such a manner that the points corresponding to the image 2L1 and the image 2R1 are consistent in lightness. In this manner, the block matching may be performed by using the image 2L1′ and the image 2R1 that are consistent in lightness. Moreover, EV is an exposure setting value that is given by log 2 {(aperture value squared)/(shutter speed)}, and when the aperture value is 1.0, and the shutter speed is 1.0 second, the result is 0.0 EV.

Next, the method of combining the images is described. In a case of the combination of the multiple images different in exposure, any one of the images is defined as the reference image, and the pixel value of the reference image is used with respect to a region imaged at the proper exposures in the reference image and the pixel value of the region corresponding to the region of the other image is used with respect to a region in which the exposure is not proper in the reference image. As a result, the images captured at the proper exposures from the bright portion to the dark portion can be combined. For example, in a case where the image 2L1 and the image 2R1 in FIG. 5 are combined with the image 2L1 as the reference, the pixel value of light photographic object image 10aL of the image 2L1, as it is, is used, with respect to the light photographic object 10a, and the pixel value of the dark photographic object image 10bR of the image 2R1 is used with respect to the dark photographic object 10b. As a result, the combination image 2LR1 can be obtained in which both of the light photographic object 10a and the dark photographic object 10b are imaged at the proper exposures as illustrated in FIG. 7.

As a method of determining whether or not the image is captured at the proper exposure in the reference image is as follows. For example, a case where the image is in 8 bits (a maximum pixel value is 255), a case where a maximum value of the pixel value RGB is, for example, 250 or above, or a case where a minimum value of the pixel value RGB is, for example, 5 or below can be determined as a case where the exposure is not proper. With regard to a threshold value for determining whether or not the exposure is proper, the proper threshold value may be set considering the specification, the characteristics and the like of the imaging system. Moreover, when combining the images, the exposure difference needs to be considered like in a case where the parallax is calculated using the block matching method. For example, in a case where the pixel of the image 2R1 is used in the combination, the pixel corresponding to the image 2L1 can be made consistent in lightness by dividing the pixel value of the image 2R1 by the exponent ΔEV to the base of 2.

Here, the calculation of the parallax using the block matching is described in more detail. As described, in a case where, at the time of the image combination, the parallax is calculated according to the block matching method, by using the pixel values of the images captured at the different exposure settings, the matching may be performed after compensating the brightness value or the pixel value of one image in such a manner that the points corresponding to both of the images are consistent in lightness, considering the exposure difference. However, in a case where the exposure difference between both of the images is great, problems described below occurs.

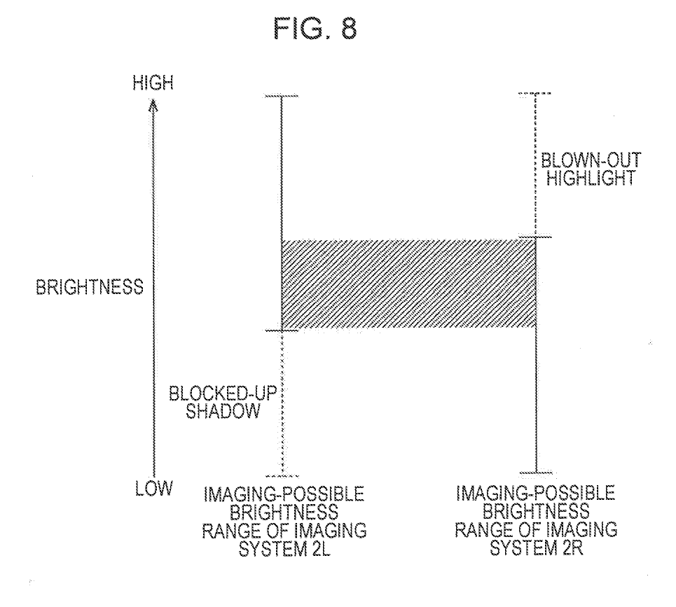

FIG. 8 illustrates brightness ranges in which the imaging systems 2L and 2R can capture the image. The image is captured by adjusting the exposure of the imaging 2L to the light portion, and adjusting the exposure of the image system 2R to the dark portion. In the drawings, the dark portion (low brightness portion) has blocked-up shadow with the imaging system 2L, the light portion (high brightness portion) has blown-out highlight with the imaging system 2R, and an oblique-lined (hatching) portion is in the brightness range in which both of the imaging system 2L and 2R overlap. In the brightness range of the oblique-lined portion, the block matching can be performed by compensating for the exposure difference of the image captured with both of the imaging systems, and the parallax can be calculated. However, in the blocked-up shadow region in the imaging system 2L, when the image value is 0, the compensation is not possible, and because even though the image value is not 0, there is a lot of noise, even though the compensation is performed, it is occasionally difficult to calculate the correct parallax. Furthermore, similarly, in the blown-up highlight region in the imaging system 2R, when the pixel value is 255, the proper compensation is not possible, and it is occasionally difficult to calculate the correct parallax.

Therefore, in order to calculate the correct parallax at the time of the image combination, it is desirable preferable that the exposure at the time of the image capture be properly controlled in such a manner that the blocked-up shadow region or the blown-out highlight region does not occur if possible in both of the imaging systems. Specifically, it is considered that the exposure difference between both of the imaging systems is controlled to be small, in such a manner that a portion in which the imaging-possible brightness ranges overlap in both of the imaging systems is increased. Moreover, the lightness and the parallax (distance) of each photographic object are necessary to set the proper exposure with respect to both of the imaging systems. For this reason, according to the present embodiment, first, both of the imaging systems 2L and 2R are set to the same exposure, and thus the same photographic object is imaged and the lightness and the parallax of each photographic object from the obtained left and right captured images are calculated. Then, the exposures of both of the imaging systems 2L and 2R are properly controlled to be adjusted to the scene, based on the calculated lightness and the parallax. In this manner, the more correct parallax can be obtained by setting the same exposure.

Moreover, with respect to the region having a likelihood of the parallax not being correctly calculated, like the blown-out highlight region and the blocked-up shadow region, for example, the parallax may be calculated by an interpolation using the parallax value of the region that is determined as a region in which the parallax is correctly calculated in the adjacent region.

Moreover, in a case where the scene to be imaged changes suddenly, there is a likelihood that the parallax will be difficult to calculate, and the setting of the exposure will not become proper. Then, in the case where the scene to be imaged changes suddenly, after once the imaging systems 2L and 2R are adjusted to the same exposure setting and the lightness and the parallax are calculated, each of the exposures of the imaging systems 2L and 2R may be again properly set.

### Second Embodiment

According to a second embodiment of the present invention, in a case where a determination unit 4 determines that a light photographic object and a dark photographic object are arranged in the front and in the rear, an exposure control unit 5 performs control in such a manner as to adjust an exposure of one imaging system to a photographic object in the background and adjust an exposure of the other imaging system to a photographic object in the foreground. Then, the same photographic object is imaged by imaging systems 2L and 2R that are controlled to the different exposures. Accordingly, multiple images used in an image combination are configured from a first image that is imaged by one imaging system with the exposure being adjusted to the photographic object in the background, and a second image that is imaged by the other imaging system with the exposure being adjusted to the photographic object in the foreground. A parallax calculation unit 3 calculates the parallax from the first image and the second image. When combining the image based on the parallax calculated by the parallax calculation unit 3, the image combination unit 6 defines the first image as a reference image, and combines the images by using a pixel value of the reference image with respect to a region in which the pixel value of the reference image is within a predetermined range, or by using a pixel value of a region corresponding to a region of the second image with respect to a region in which the pixel value of the reference image is not within the predetermined range. The second embodiment is described below with a specific example illustrated.

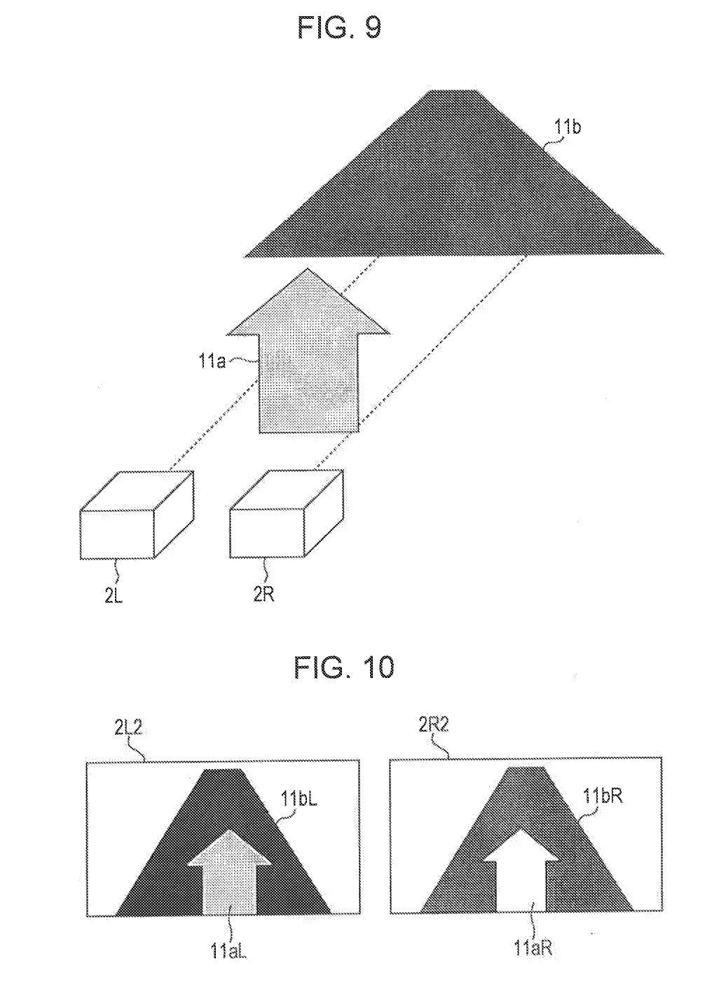

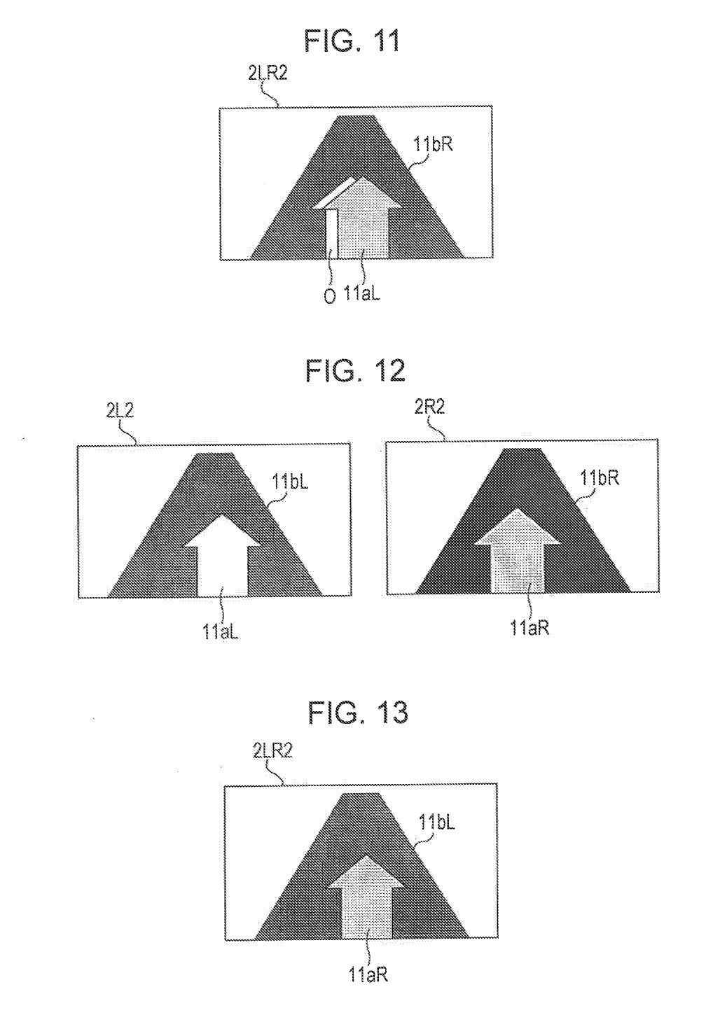

FIG. 9 is a view schematically illustrating one example in a case where the light photographic object (light portion) and the dark photographic object (dark portion) arranged in the front and in the rear, are imaged by using two imaging systems 2L and 2R, arranged on the left side and on the right side. In the drawings, reference numeral 11a indicates the light photographic object, and reference numeral 11b indicates the dark photographic object. Furthermore, FIG. 10 illustrates an image 2L2 that is imaged by adjusting the exposure of the imaging system 2L to a light photographic object 11a, and an image 2R2 that is imaged by adjusting the exposure of the imaging system 2R to a dark photographic object 11b. In FIG. 10, when the image 2L2 adjusted to the light photographic object 11a in the foreground is defined as the reference, and the image 2L2 and the image 2R2 are combined, the pixel value of a light photographic object image 11aL of the image 2L2 may be used for the light photographic object 11a that is imaged at the proper exposure, and has not blown-out highlight and blocked-up shadow in the image 2L2, or the pixel value of a dark photographic object image 11bR of the image 2R2 may be used for the dark photographic object 11b that is not imaged at the proper exposure in the image 2L2. Accordingly, as illustrated in FIG. 11, a combination image 2LR2 is obtained which is captured at the proper exposure from a bright portion to a dark portion.

However, in the combination image 2LR2 in FIG. 11, there is a problem in that the left side of the light photographic object image 11aL becomes an occlusion region O and the image quality deteriorates. The occlusion region O is a result of imagining the dark photographic object 11b in the image 2L2 in FIG. 10, but is a result of imaging the light photographic object 11a in the image 2R2 and the dark photographic object 11b becomes a shadow of the light photographic object 11a. In this manner, the region of which the image is captured with one imaging system, and is not captured with the other imaging system is defined as the occlusion. Because the occlusion region O indicated with a white color in FIG. 11 has the blocked-up shadow in the image 2L2 in FIG. 10, it is preferable to use the pixel value of the image 2R2 imaged at the proper exposure for the combination, but the pixel is not present in the corresponding region because the occlusion results in the image 2R2. Accordingly, an image quality deteriorates because when combining the images, there is a need to use the wrong pixel value in the combination, and to use the pixel value of the image 2L2 in which the exposure is not adjusted.

In contrast, FIG. 12 illustrates the image 2L2 that is imaged by adjusting the exposure of the imaging system 2L to the dark photographic object 11b and the image 2R2 that is imaged by adjusting the exposure of the imaging system 2R to the light photographic object 11a. Furthermore, FIG. 13 illustrates the image that combines the image 2L2 and the image 2R2. In a case of the example in FIG. 12, unlike in the example in FIG. 10, the image 2L2 (equivalent to the first image) in which the exposure is adjusted to the dark photographic object 11b in the background is defined as the reference, and the pixel value of a dark photographic object image 11bL of the image 2L2 imaged at the proper exposure is used for the dark photographic object 11b, or the pixel value of a light photographic image 11aR of the image 2R2 (equivalent to the second image) is used for the light photographic object 11a that is not imaged at the proper exposure in the image 2L2. At this time, because the pixel of the dark photographic image 11bL of the image 2L2 is present the occlusion region O illustrated in FIG. 11, the deterioration due to the occlusion does not occur as illustrated in FIG. 13.

That is, in FIG. 12, in the image 2L2, the region of the light photographic object image 11aL becomes the blown-out highlight region, without being imaged at the proper exposure. On the one hand, in the image 2R2, the region of the light photographic object image 11aR is imaged at the proper exposure. The light photographic object image 11aL of the image 2L2 and the light photographic object image 11aR of the image 2R2 deviate only by the parallax, but because the parallax of each photographic object is calculated between the image 2L2 and the image 2R2, the pixel value of the region that deviates only by the parallax in the image 2R2 can correspond to the pixel value of the region of the light photographic object image 11aR. In this manner, the occlusion can be prevented from occurring by assigning the pixel value of the region of the light photographic object image 11aR of the image 2R2 to the region of the light photographic object image 11aL of the image 2L2, and thus by performing the image combination.

As described above, in a case where the two photographic objects different in lightness are present in the front and in the rear, the avoidance of the deterioration in the image quality due to the occlusion at the time of the image combination may be possible by capturing the image by adjusting the exposure of the imaging system defined as the reference to the photographic object at a great distance and by capturing the image by adjusting the exposure of the other imaging system to the photographic object at a short distance.

Next, the setting method in a case where the two photographic objects different in lightness are present in the front and in the rear is described. As described above, in the case where the two photographic objects different in lightness are present in the front and in the rear, the image combination without the deterioration in the image quality can be performed by capturing the image by adjusting the exposure of the imaging system defined as the reference to the photographic object at a great distance (on the background) and by adjusting the exposure of the other imaging system to the photographic object at a short distance (on the foreground). At this time, information on the lightness of the photographic object and information on a distance to the photographic object are necessary.

The lightness, for example, is calculated by using RAW data that have a linear value with respect to an amount of light entering a CCD sensor, and a brightness value of lightness can be approximately calculated. Furthermore, the lightness may be calculated by using the pixel value (RGB value) of the image. In a case of using the pixel value, it is not easy to calculate the precise brightness, but because knowledge of a trend in a lightness level of the photographic object can be obtained, the pixel value is sufficient as information necessary when setting the exposure. Furthermore, a light measurement sensor may be used such as a brightness photometer.

For example, there is a method of calculating the information on the distance by using a distance measurement sensor, or the parallax. In a case of using the parallax, for example, in a case where the image is captured by arranging the two imaging systems in such a manner that light axes of the two imaging systems are parallel to each other, the closer the photographic object is to the front, the greater the parallax, and the farther the photographic object from the front, the smaller the parallax, and the parallax of the photographic object at infinity becomes zero. Therefore, a front-rear relationship of the photographic object can be determined by the level of the parallax. Furthermore, when a specification for the imaging system, such as a focal point distance, and a pixel pitch of a sensor is well-known, the distance to the photographic object can be calculated from the parallax value.

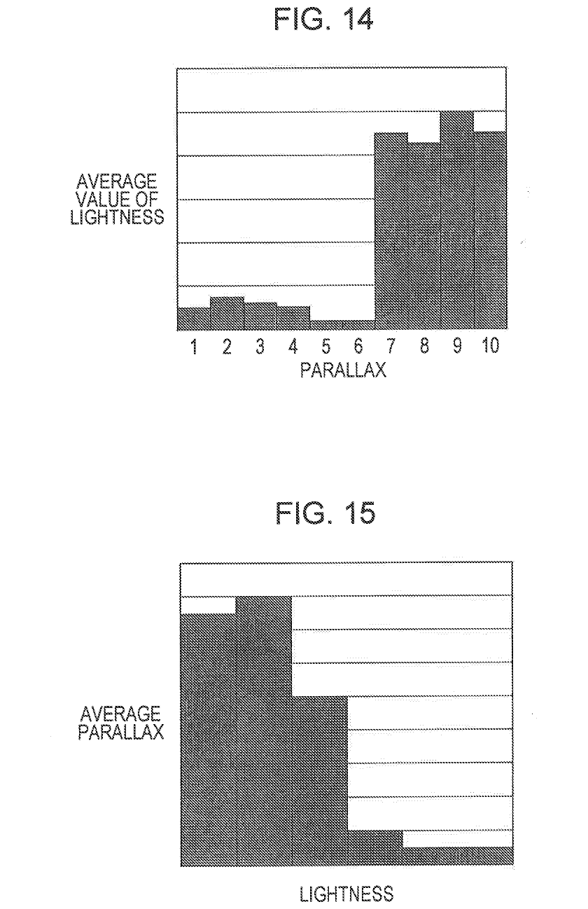

Next, a method of setting the exposure of the imaging system based on the information on the lightness of the photographic object and the information on the distance to the photographic object is described. According to the present embodiment, since the exposure of the imaging system defined as the reference is adjusted to the background and the exposure of the other imaging system is adjusted to the foreground, for example, a certain parallax value may be divided into the foreground and the background, as threshold values, based on the information, the average value of lightness in each parallax. FIG. 14 illustrates one example of the average value of lightness in each parallax of a certain scene. In the example, the parallaxes 1 to 6 are small in the average value of lightness, and the parallax 7 or greater is great in the average value of lightness. Therefore, it can be said that the foreground is light and the background is dark. Then, the exposure of the imaging system defined as the reference may be set in such a manner that the background, for example, the region with the parallax 6 or smaller are imaged at the proper exposure (here, the exposure that is adjusted to the dark photographic object), and the exposure of the other imaging system may be set in such a manner that the foreground, for example, the region with the parallax 7 or greater are imaged at the proper exposure (here, the exposure that is adjusted to the light photographic object).

Furthermore, the division into the foreground and the background may be made based on the information on the average parallax in each lightness. FIG. 15 illustrates one example of the average parallax in each lightness of a certain scene. In the present example, since the average parallax of a light region is small and the average parallax of a dark region is great, it can be determined that the foreground is dark and the background is light. Therefore, the exposure of the imaging system defined as the reference may be adjusted to the light portion (background) and the exposure of the other imaging system may be adjusted to the dark portion (foreground). Furthermore, the exposure of the imaging system defined as the reference may be adjusted to the region with the minimum parallax, and the exposure of the other imaging system may be adjusted to a region other than the region with the minimum parallax. Furthermore, the imaging system defined as the reference may be adjusted to the region other than the region with the maximum parallax, and the other imaging system may be adjusted to the region with the maximum parallax.

### Third Embodiment

According to a third embodiment of the present invention, in a case where a determination unit 4 determines that a light photographic object and a dark photographic object are alternately arranged in the depth direction, an exposure control unit 5 performs control in such a manner as to adjust an exposure of one imaging system to a light photographic object and adjust an exposure of the other imaging system to a dark photographic object. Then, the same photographic object is imaged by imaging systems 2L and 2R that are controlled to the different exposures. Accordingly, multiple images used in an image combination are configured from a first image that is captured by one imaging system with the exposure being adjusted to the light photographic object, and a second image that is captured by the other imaging system with the exposure being adjusted to the dark photographic object. A parallax calculation unit 3 calculates the parallax from the first image and the second image. When combining the image based on the parallax calculated by the parallax calculation unit 3, an image combination unit 6 defines one image of the first image and the second image, in which the exposure is adjusted to the second photographic object from the front, as a reference image, and combines the images by using a pixel value of the reference image with respect to a region in which the pixel value of the reference image is within a predetermined range, or by using a pixel value of a region corresponding to a region of the other image with respect to a region in which the pixel value of the reference image is not within the predetermined range. The third embodiment is described below with a specific example illustrated.

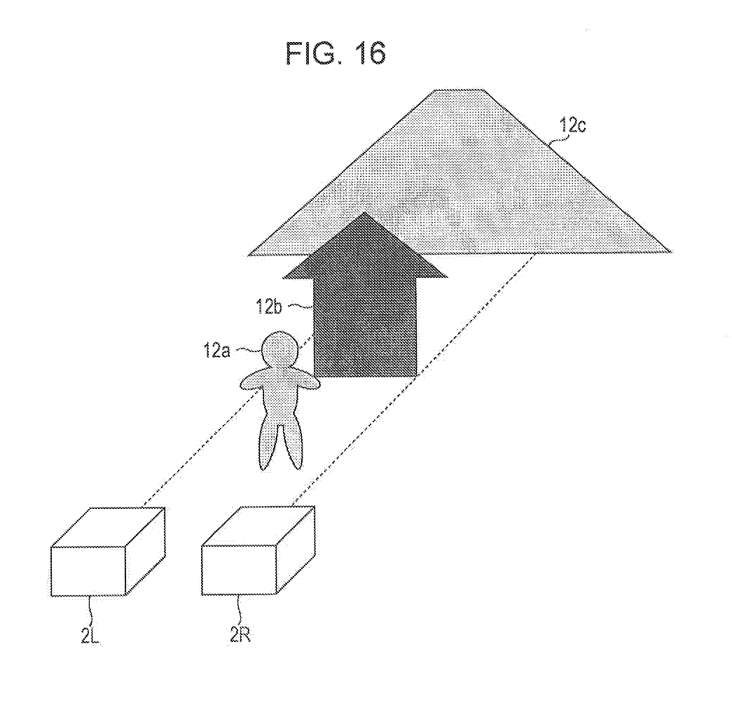

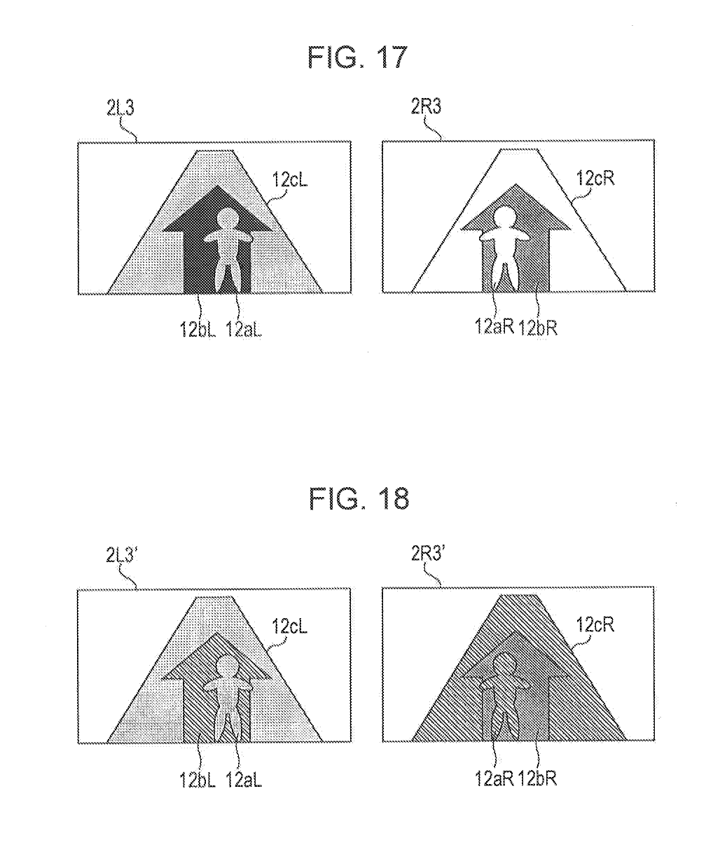

FIG. 16 is a view schematically illustrating one example in a case where the photographic objects, arranged in this sequence of the light photographic object, the dark photographic object, the light photographic object, are imaged by using the two imaging systems 2L and 2R arranged on the left side and on the right side. In the drawings, reference numeral 12a indicates the light photographic object, reference numeral 12b indicates the dark photographic object, and reference numeral 12c indicates the light photographic object. FIG. 17 illustrates an image 2L3 that is imaged by adjusting the exposure of the imaging system 2L to the light photographic objects 12a and 12c, and an image 2R3 that is imaged by adjusting the exposure of the imaging system 2R to the dark photographic object 12b. In FIG. 17, a dark photographic object image 12bL has blocked-up shadow in the image 2L3, and the light photographic object image 12aR and the light photographic object image 12cR have the blown-out highlight in the image 2R3. When the image 2L3 and the image 2R3 are used in the combination, the light photographic object 12a and 12c may use the pixel values of the light photographic object images 12aL and 12cL of the image 2L3, and the dark photographic object 12b may use the pixel value of the dark photographic object image 12bR of the image 2R3.

Furthermore, an image 2L3′ in FIG. 18 indicates regions (12aL and 12cL) that are imaged at the proper exposures in the image 2L3 in FIG. 17, with a light gray, and indicates a region (12bL) that has the blocked-up shadow, with oblique lines. Furthermore, an image 2R3′ in FIG. 18 indicates a region (12bR) that is imaged at the proper exposure in the image 2R3 in FIG. 17, with the deep gray, and indicates regions (12aR and 12cR) that have the blown-out highlight, with oblique lines.

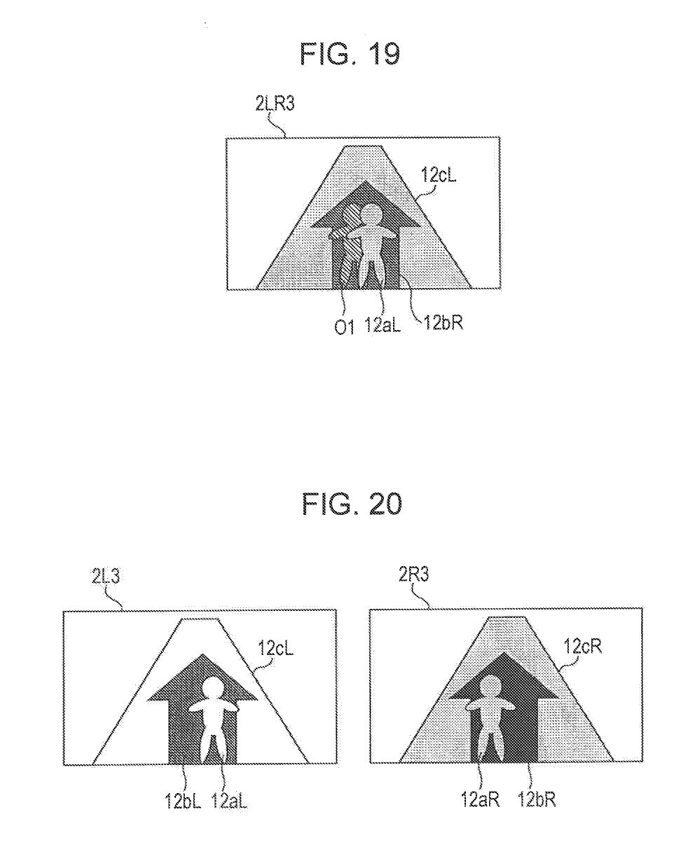

Here, one part of the dark photographic object 12b becomes a shadow of the light photographic object 12a, and one part of the light photographic object 12c becomes a shadow of the dark photographic object 12b. At this time, because the region 12bL has the blocked-up shadow in the image 2L3, the pixel value of the region 12bR of the image 2R3 is preferably used, but the blown-out highlight region 12aR is present and the corresponding pixel is not present in one part of the region 12bR of the image 2R3. Therefore, when the image 2L3 and the image 2R3 in FIG. 17 are image-combined, an occlusion region O1 (oblique-lined region) occurs as illustrated in FIG. 19.

That is, in FIG. 17, in the image 2L3, the region of the dark photographic object image 12bL becomes the blocked-up shadow region, without being imaged at the proper exposure. On one hand, in the image 2R3, the region of the dark photographic object image 12bR is imaged at the proper exposure. The dark photographic object image 12bL of the image 2L2 and the dark photographic object image 12bR of the image 2R2 deviate only by their respective parallaxes, but because the parallax of each photographic object is calculated between the image 2L3 and the image 2R3, the pixel value of the region that deviates only by the parallax in the image 2R3 can correspond to the pixel value of the region of the dark photographic object image 12bR. In this manner, the image combination is performed by assigning the pixel value of the region of the dark photographic object image 12bR of the image 2R3 to the region of the dark photographic object image 12bL of the image 2L3, but because the blown-out highlight region 12aR is present and the corresponding pixel is not present in one part of the region of the dark photographic object image 12bR of the image 2R3, the occlusion (FIG. 19) results when the image combination is made.

In contrast, FIG. 20 illustrates the image 2L3 (equivalent to the second image) that is imaged by adjusting the exposure of the imaging system 2L to the dark photographic object 12b, and the image 2R3 (equivalent to the first image) that is imaged by adjusting the exposure of the imaging system 2R to the dark photographic objects 12a and 12c. In FIG. 20, the light photographic object images 12aL and 12cL have the blown-out highlight in the image 2L3, and the dark photographic object image 12bR has the blocked-up shadow in the image 2R3. When the image 2L3 and the image 2R3 are used in the combination, the dark photographic object 12b may use the pixel value of the dark photographic object images 12bL of the image 2L3, and the light photographic objects 12a and 12c may use the pixel values of the light photographic object images 12aR and 12cR of the image 2R3.

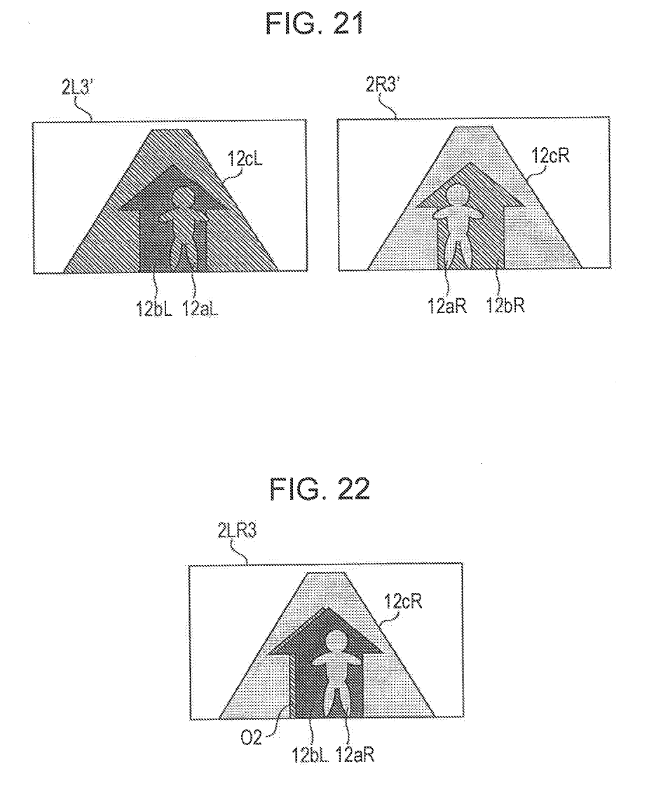

Furthermore, the image 2L3′ in FIG. 21 indicates a region (12bL) that is imaged at the proper exposure in the image 2L3 in FIG. 20, with the deep gray, and indicates regions (12aL and 12cL) that have the blown-out highlight, with the oblique lines. Furthermore, the image 2R3′ in FIG. 21 indicates regions (12aR and 12cR) that are imaged at the proper exposures in the image 2R3 in FIG. 20, with the light gray, and indicates the region (12bR) that has the blocked-up shadow, with the oblique lines.

Here, as in the example in FIG. 17, one part of the dark photographic object 12b becomes the shadow of the light photographic object 12a, and one part of the light photographic object 12c becomes the shadow of the dark photographic object 12b. At this time, because the regions 12aL and 12cL of the image 2L3 have the blown-out highlight, the pixel values of the regions 12aR and 12cR of the image 2R3 is preferably used, but the blocked-up shadow region 12bR is present and the corresponding pixel is not present in one part of the region 12cR of the image 2R3. Therefore, when the image 2L3 and the image 2R3 in FIG. 20 are image-combined, an occlusion region O2 (oblique-lined region) occurs as illustrated in FIG. 22.

That is, in FIG. 20, in the image 2L3, the regions of the light photographic object image 12aL and 12cL become the blown-out highlight region, without being imaged at the proper exposures. On the one hand, in the image 2R3, the regions of the light photographic object images 12aR and 12cR are imaged at the proper exposures. The light photographic object images 12aL and 12cL of the image 2L2 and the light photographic object image 12aR and 12cR of the image 2R2 deviate only by their respective parallaxes, but because the parallax of each photographic object is calculated between the image 2L3 and the image 2R3, the pixel values of the regions that deviate only by the parallax in the image 2R3 correspond to the pixel values of the regions of the light photographic object images 12aR and 12cR. In this manner, the image combination is performed by assigning the pixel values of the regions of the light photographic object images 12aR and 12cR of the image 2R3 to the regions of the light photographic object images 12aL and 12cL of the image 2L3, but because the blocked-up shadow region 12bR is present and the corresponding pixel is not present in one part of the region of the light photographic object image 12cR of the image 2R3, the occlusion (FIG. 22) results when the image combination is made.

As described above, it can be said that even in a case where the image is captured by adjusting the exposure of the imaging system 2L to the dark photographic object 12b and by adjusting the exposure of the imaging system 2R to the light photographic objects 12a and 12c, or even in a case where the image is captured by adjusting the exposure of the imaging system 2L to the light photographic objects 12a and 12c and by adjusting the exposure of the imaging system 2R to the dark photographic object 12b, there is a likelihood that the occlusion will occur at the time of the image combination, and the image quality will deteriorate. However, as illustrated in FIG. 19 and FIG. 22, the occlusion region has as high a likelihood of occurrence as the photographic object in the front, and additionally an area of the occlusion region is increased. As apparent from the fact that the occlusion regions O1 and O2 indicated by the oblique lines in FIG. 19 and FIG. 22 are different in size, a way (an example in FIG. 22) in which the image is captured by adjusting the exposure of the imaging system 2L defined as the reference to the dark photographic object 12b and by adjusting the exposure of the imaging system 2R to the light photographic object 12a and 12c can decrease the occlusion region and suppress the deterioration in the image quality. That is, it is possible to decrease an influence of the occlusion region by defining as the reference image the image 2L3 in which the exposure is adjusted to the second dark photographic object 12b from the front, of the image 2L3 and the image 2R3.

Furthermore, as opposed to the example in FIG. 16, even in a case where the dark photographic object, the light photographic object, and the dark photographic object are arranged in a line from the front in this sequence, it can be said that a way in which the image is captured by adjusting the exposure of the imaging system 2L defined as the reference to the second light photographic object from the front, and by adjusting the exposure of the imaging system 2R to the dark photographic object can decrease the region in which the image quality deteriorates due to the occlusion. In other words, from the perspective of the imaging system, even in a case where the light photographic object, the dark photographic object, and the light photographic object are arranged in a line in this sequence from the front, or even in a case where the dark photographic object, the light photographic object, and the dark photographic object are arranged in a line in this sequence from the front, the region in which the image quality deteriorates due to the occlusion when combining the images can be decreased by adjusting the exposure of the imaging system defined as the reference to the second photographic object from the front.

The embodiments described above is also applied to a large scale integration (LSI) that is an integrated circuit mounted on the imaging apparatus. That is, each function block of the imaging apparatus may be individually built into a chip, and one part or all of the function blocks may be integrated into a chip. Furthermore, a technique of the integrated circuit is not limited to LSI, and the integrated circuit for the function block may be realized as a dedicated circuit or a general-purpose processor. For example, processing, such as the parallax calculation, the determination, the exposure control and the image combination can be realized as hardware processing, such as a field programmable gate array (FPGA) and an application specific integrated circuit (ASIC), or as software processing by a microcomputer.

### REFERENCE SIGNS LIST

1 IMAGING APPARATUS
2 IMAGING SYSTEM
3 PARALLAX CALCULATION UNIT
4 DETERMINATION UNIT
5 EXPOSURE CONTROL UNIT
6 IMAGE COMBINATION UNIT

1-8. (canceled)

9. An imaging apparatus, comprising:
multiple imaging systems;
a parallax calculation unit that calculates parallaxes of multiple images that are captured by the multiple imaging systems;
a determination unit that determines a lightness-level relationship and a positional relationship of a photographic object in the multiple images;
an exposure control unit that is able to control the multiple imaging systems with respective different exposures based on a result of the determination by the determination unit; and
an image combination unit that combines the multiple images based on the parallaxes and the exposures,
wherein in a case where the determination unit determines that a light photographic object and a dark photographic object are arranged in the front and in the rear, the exposure control unit performs control in such a manner that the exposure control unit adjusts the exposure of the imaging system that captures a reference image defined as a reference when combining the multiple images, to the photographic object in the background and adjusts the exposure of the other imaging system to the photographic object in the foreground.

10. The imaging apparatus according to claim 9,
wherein the multiple images is configured a first image that is captured by the imaging system imaging the image defined as the reference with the exposure being adjusted to the photographic object in the background, and a second image that is captured by the other imaging system with the exposure being adjusted to the photographic object in the foreground, the parallax calculation unit calculates the parallax from the first image and the second image, and the image combination unit combines the images by using a pixel value of the first image with respect to a region in which the pixel value of the first image is within a predetermined range, or using a pixel value of a region corresponding to the region of the second image with respect to a region in which the pixel value of the first image is not within the predetermined range, when combining the images based on the parallax calculated by the parallax calculation unit.

11. An imaging apparatus comprising:
multiple imaging systems;
a parallax calculation unit that calculates parallaxes of multiple images that are captured by the multiple imaging systems;
a determination unit that determines a lightness-level relationship and a positional relationship of a photographic object in the multiple images;
an exposure control unit that is able to control the multiple imaging systems with respective different exposures based on a result of the determination by the determination unit; and
an image combination unit that combines the multiple images based on the parallaxes and the exposures,
wherein in a case where the determination unit determines that a light photographic object and a dark photographic object are alternately arranged in the depth direction, the exposure control unit performs control in such a manner that the exposure control unit adjusts the exposure of the imaging system that captures the image defined as a reference when combining the multiple images, to the photographic object different in lightness from the photographic object in the front and adjusts the exposure of the other imaging system to the photographic object in the front.

12. The imaging apparatus according to claim 11,
wherein the multiple images are configured from a first image that is captured by the imaging system that captures the image defined as the reference with the exposure being adjusted to the photographic object different in lightness from the photographic object in the front and a second image that is captured by the other imaging system with the exposure being adjusted to the photographic object in the front, the parallax calculation unit calculates the parallax from the first image and the second image, and the image combination unit combines the images by using a pixel value of the first image with respect to a region in which the pixel value of the first image is within a predetermined range, or using a pixel value of a region corresponding to the region of the second image with respect to a region in which the pixel value of the first image is not within the predetermined range, when combining the images based on the parallax calculated by the parallax calculation unit.

13. The imaging apparatus according to claim 9,
wherein the exposure control unit controls the multiple imaging systems to the same exposure, the parallax calculation unit calculates the parallaxes of the multiple images captured by the multiple imaging systems that are controlled to the same exposure by the exposure control unit, the determination unit determines a lightness-level relationship of each photographic object based on the pixel values of the multiple images and determines a positional relationship of each photographic object based on the parallax of each photographic object calculated by the parallax calculation unit.
